(19) United States
(12) Patent Application Publication
(10) Pub. No.: US 2009/0110058 A1
(43) Pub. Date: Apr. 30, 2009

(54) Smart image processing CCTV camera device and method for operating same

(76) Inventor: Lien-Chieh Shen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/289,555

(22) Filed: Oct. 30, 2008

Related U.S. Application Data
(62) Division of application No. 10/983,693, filed on Nov. 9, 2004.

(51) Int. Cl. H04N 7/26; H04N 5/225

(52) U.S. Cl. 375/240.01; 348/155; 375/E07.111

(57) ABSTRACT

A smart image processing CCTV camera device and a method for operating the same are proposed. The camera can process, compress and store digital images, and zoom to a captured image using a digital image-capturing component therein. It can also restore the captured image to either an analog or a digital signal for transmission or replay of captured images immediately or at a later time. Moreover, the camera can also perform motion image analysis and tracking and can also perform optical or digital image zooming on a tracked image to monitor an object and ensure a clear image is captured.

### RELATED APPLICATIONS

This application is a Divisional patent application of co-pending application Ser. No. 10/983,693, filed on 9 Nov. 2004. The entire disclosure of the prior application, Ser. No. 10/983,693, from which an oath or declaration is supplied, is considered a part of the disclosure of the accompanying Divisional application and is hereby incorporated by reference.

### BACKGROUND OF THE INVENTION

1. Field of the invention

The present invention relates to a camera capable of performing digital image processing and also automatically analyzing motion image and tracks the captured image automatically to monitor an area and provide clear images should they be required at a later time.

2. Description of Related Art

A closed circuit TV (CCTV) monitor system is an important element in a safety guard system, and is commonly deployed in public places and residences. It is an integrated system of image capturing, processing and monitoring. Its remote control camera and peripheral equipments are used to directly watch all areas of the monitored place. The CCTV monitor system can also operate jointly with other safety guard systems like various burglarproof alarm systems thereby enhancing the capability of security precautions and assists in the prompt discovery of criminal behavior, property destruction, and also helps reduce crime, and so on.

A CCTV system records a monitored area where it is impractical to have security personnel directly observing the area. It has become an efficient monitoring tool. Through the help of CCTV system, only a single person at a control center is required to watch over many different places and even faraway regions.

As shown in FIG. 1, conventional CCTV cameras 15a, 15b, and 15c can connect a remote monitoring system such as a remote monitor 11 and a video recording system 13 in a wireless or a wired way. In the prior art, fixed CCTV cameras or periodically turning cameras send the captured images (probably including sound files) in analog format to a remote monitoring center. The audiovisual data can come from the cameras 15a, 15b, and 15c disposed in different places. The monitoring center staff can use split frames on a monitor 11 to facilitate watching and monitoring the images, and a video recording system 13 is used to record the frames onto video tapes or various other storage media.

An image splitting system can also be used to split the frame on a monitor into between 4 and 16 images originating from different cameras so that a single person can easily monitor many places simultaneously. In the prior art, the recorded split images of a video recording system 13 couldn't clearly reflect photographed objects because the image on the monitor was shared by many different frames. Hence any analysis of events afterwards was seriously affected. Moreover, the cameras generally take images in a fixed turning way, leaving many dead angles in time and space. As such, key events were often unseen. Moreover, the images being played in the monitor cannot automatically inform the monitoring staff of the situation in the monitored area.

R.O.C. Pat. No. TW421394 discloses an automatic tracking and monitoring device. FIG. 2 shows the architecture of such a tracking system, wherein a central processor 20 connects a plurality of peripheral devices like a system setting module 21 that is responsible for fixing/following/scanning modes of photographing. The central processor 20 is connected to an antenna 22 via a wireless audiovisual emission module 23 to transmit and receive wireless signals. The central processor 20 is also connected to a camera 27 via a camera setting module 24, and is connected to a servo motor 26 to control the turning of the camera 27. The central processor 20 is further connected with two infrared sensors 25′ and 25″. The central processor 20 will control the action of the camera 27 through the servo motor 26 and the camera setting module 24 according to the motion of a photographed object detected by the two infrared sensors.

The photographed object is detected through a complement of the two infrared sensors. A single sensor is incapable of making a decision in accordance with the behavior of the photographed object. Moreover, the monitoring system can't inform monitoring staff of suspicious activities.

CCTV cameras have been used for a long time. Existing CCTV cameras can only process image data obtained by their sensors via a lens and convert that information into analog NTSC or PAL TV signals for outputting to a rear-end host device for recording and monitoring. A common CCTV monitoring system has the following drawbacks in consideration of cost and system complexity.
1. Each CCTV camera has a fixed monitoring range thus making it difficult to discriminate between captured objects due to the small size of the photographed images.
2. A certain number of cameras can be integrated through a multiplexer to display images upon the same monitor (e.g., 16 or 9 split frames) so that only two or three 1/16 frames of each camera are recorded after the operation of the multiplexer for 30 frames/sec full screen speed.

Key frames may as such be lost.
3. Analog signals decay relative to their distance over which they are transmitted causing noise to be added to the recorded sounds and a blurring of the image.

In order to solve the above drawbacks of conventional CCTV cameras, the present invention proposes a device applying digital signal processing technology to CCTV cameras. Moreover, image analysis techniques are used to accomplish automatic detection and tracking functions that can't be carried out by the CCTV cameras themselves.

In the present invention, digital image processing, compression, storage, and zoom modules are provided within the camera itself. Analog or digital signals can be restored immediately or at a later time for transmission or replay. In other words, motion image analysis and tracking can be performed to the captured images making monitoring of an area easier and ensuring the images can be seen easily.

### SUMMARY OF THE INVENTION

One objective of the present invention is to provide a smart image processing CCTV camera device and a method for operating the same. The camera processes, compresses, stores, and zooms to the captured digital images automatically. Analog or digital signals can be restored immediately or at a later time for transmission or replay. In other words, motion image analysis and tracking can be performed on the captured images to accomplish monitoring and clear analysis of an image.

The smart image processing CCTV camera device comprises a highly integrated image system on chip (SOC). The image SOC comprises of at least an image sensor processing unit for controlling and adjusting signals outputted by an image sensor, a color image processing unit for receiving outputted signals from the image sensor, converting image formats, and performing image quality adjustment, a motion image analysis and tracking unit for analyzing previous and next images to find out the motion vector of a tracked object, an image compression/decompression unit for performing compression and decompression actions to static or dynamic images to facilitate storage or replay, a central processing unit for coordinating and controlling the operation of the entire system, a memory medium control unit for controlling write/read image signals on various storage media, an external control unit for outputting or receiving control signals and communicating with external components or systems controlling a lens, or being operated by the external control unit, an analog image signal transmission interface for converting the image signal into an analog format (e.g., NTSC or PAL) and outputting the analog image signal out, and a digital image signal transmission interface (e.g., USB interface or wired/wireless network interface) for converting the image signal into a digital format and outputting the digital image signal out.

A method for operating the smart image processing CCTV camera device comprises the steps of capturing an image, performing image processing, performing image comparison, performing automatic tracking, performing image zoom, performing compression and storage, performing image replay, and performing image transmission.

The various objectives and advantages of the present invention will be more readily understood from the following detailed description when read in conjunction with the appended drawing, in which:

### BRIEF DESCRIPTION OF THE DRAWINGS

FIG. 1 is a diagram of a conventional CCTV system;

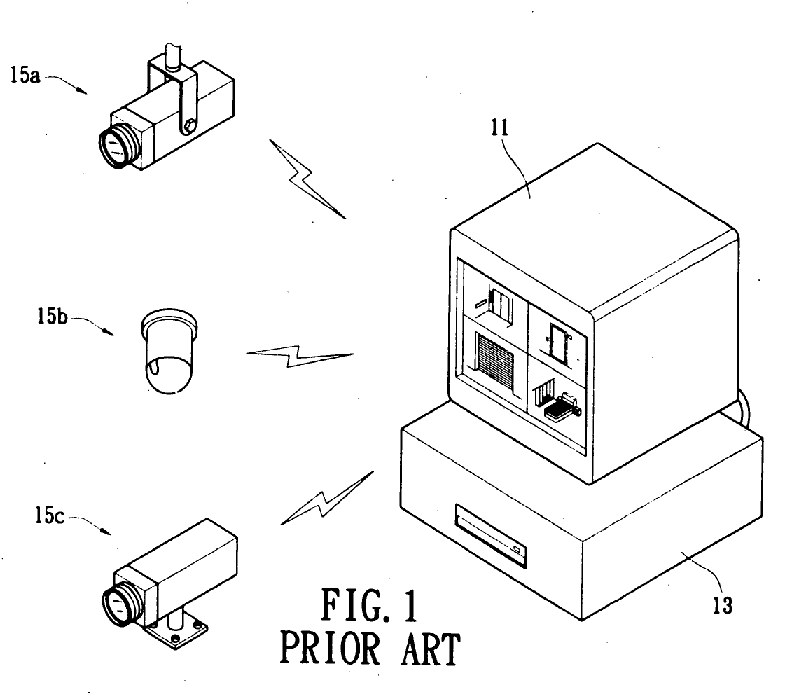

FIG. 2 is an architecture diagram of a conventional CCTV tracking system;

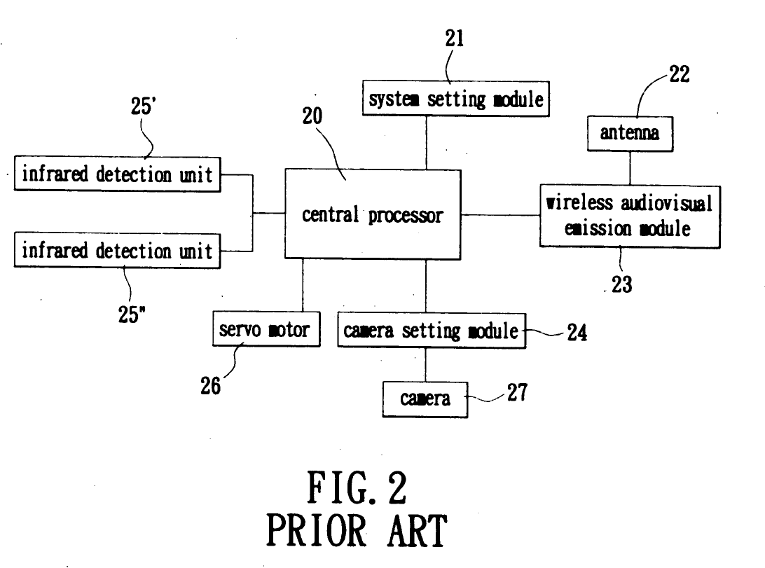

FIG. 3 is a diagram of a smart image processing CCTV system of the present invention;

FIG. 4 is an architecture diagram of a smart image processing CCTV camera of the present invention;

FIG. 5 is an operational flowchart for a smart image processing CCTV camera of the present invention; and

FIG. 6 is a flowchart for object tracking according to an embodiment of the present invention.

### DETAILED DESCRIPTION OF THE PREFERRED EMBODIMENTS

The present invention provides a smart image processing CCTV camera device and a method for operating the same. A highly integrated digital image system on chip (SOC) is disposed within a CCTV camera so that the camera has digital image processing capability to capture images by itself. In other words, motion image analysis and tracking can be performed to the captured images to monitor an area and ensure a clear image is captured.

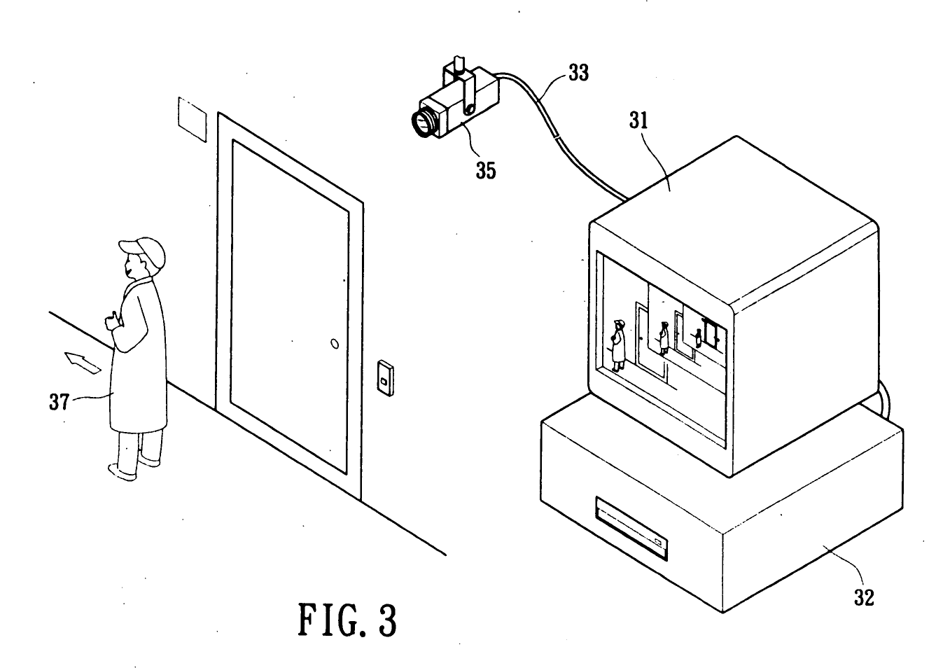

As shown in FIG. 3, a CCTV system is connected to a camera and a remote monitoring system to remotely monitor, control, and record for storage and replay, and so on. The CCTV camera of the present invention is connected to a remote monitor 31 via a transmission medium 33 in either a wired or wireless way. In addition, the camera itself can store audiovisual data in its own storage medium in digital format; an audiovisual recording system 32 can also be used for storage in digital or analog format.

The automatic detection and tracking of a photographed object of the present invention is accomplished by analyzing the difference between previous and their subsequent images. During the process of photographing, the camera transmits image data to a monitor center and also compares the image being photographed with the previously stored digital image . If the object has moved (e.g., the photographed object 37 in the figure walks), photographing actions like tracking and zoom will be performed to the photographed object to inform the monitoring staff to take appropriate actions. Because the image data is transmitted and stored in digital format, the problems of interference due to transmission or deterioration of the image resolution due to the use of split frames don't arise.

The CCTV camera of the present invention itself is capable of processing, compressing and storing digital images. These images can later be examined in greater detail by zooming in on the images so a clearer picture can be examined. Analog or digital signals can be restored, transmitted and shown immediately or at a later time. Digital image processing in the camera is achieved using a digital image sensor like a CCD sensor or a CMOS sensor to get original pixel or audiovisual data. After processing (including, for example, auto exposure, auto white balance, interpolation, RGB to YCbCr conversion, image sharpening) good-quality digital data can be obtained. Digital compression and storage can then be provided.

Auto exposure, as mentioned in the preceding paragraph, means that the camera can automatically adjust the exposure time and assess whether its brightness setting is suitable under its current environment. If there is another light source, the average brightness value of each pixel in the entire frame can be determined. Under normal conditions, the average brightness value usually lies between 115 to 125, but is not limited in this range. Good image quality can thus be obtained under environments with different light source brightness.

Human eyes automatically compensate for the color tone under light sources with different color tones. As such, almost the same color will be observed for the same object under different light sources. A CCD sensor or a CMOS sensor, however, cannot automatically make such compensations. The previously mentioned auto white balance is thus required to provide such compensation. Therefore, the problem of color shifting towards the dominant colors of the photographed object doesn't arise, as is experienced with CCTV cameras of the prior art, and an image as it would be seen by the human eye will be shown.

A digital image sensor makes use of many image sensor cells to take an image signal of each pixel. The image signal taken by each image sensor cell does not include the three primary colors (R, G, and B) of each pixel. A filter is used so that individual image sensor cell records a single color, and the image sensor cells are alternately arranged in the horizontal and vertical directions. Different image sensors may have different ways of performing such arrangements. When a digital image sensor cell gets a preliminary image, it is necessary to perform interpolation to calculate the other two primary colors of each pixel, thereby obtaining a complete digital image.

After interpolation, the RGB values of each pixel are converted to YCbCr values, where Y represents the brightness and Cb and Cr represent the chroma. Because human eyes are more sensible to brightness variation than to chroma variation, part of the chroma data can be abandoned after conversion to reduce the amount of data. Besides, subsequent image processing like sharpening, softening, and compression are primarily controlled by the brightness data.

Situations may occur where an image is blurred after interpolation is performed upon a digital image. Sharpening reinforces the edge lines of an object by performing calculations to enhance the entire sharpness of an image.

Digital image compression can be performed upon a single image or continuous images. For a single image taken by a camera, the different sensitivities to color and detail of human eyes are exploited so that memory can be reserved for more important data. As such, color differences and image details indistinguishable by human eyes are discarded through various conversions and calculations, thereby reducing of the amount of data that needs to be stored. The above processed image data can be recorded in a statistically encoded way to further reduce the amount of data. For continuous images, in addition to the above compression method for a single image, variation between previous and subsequent images can be compared to calculate local movement and then replace an encoded image with an encoded movement, thereby greatly increasing the compression ratio.

After the image is processed and compressed, the resultant digital data is converted to corresponding formats and stored in various digital storage devices including DRAM (SDRAM and DDRAM), flash memory, memory card, hard disk drive, or optical disc (CD-R/RW, DVD).

Image zoom is accomplished by increasing the entire or local resolution of the obtained digital image to facilitate the recognition of the image of an object. The increased points for enhancing the resolution are obtained through neighboring relevant points after calculation and then inserted into the original image. Next, the zoomed image is sharpened or softened to enhance the image quality.

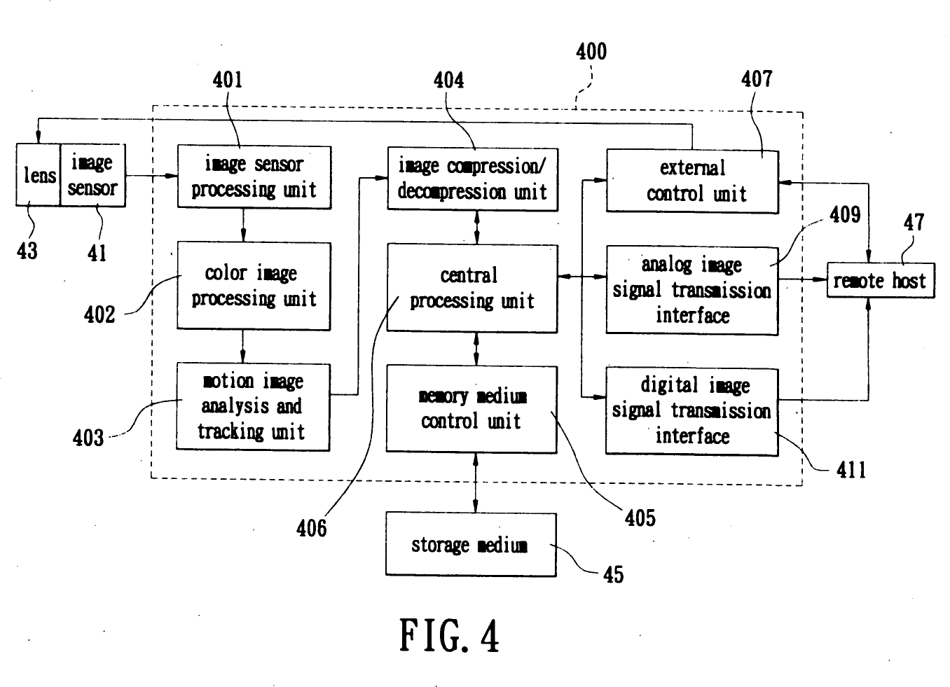

FIG. 4 is an architecture diagram of a smart image processing CCTV camera of the present invention. Various function modules of the CCTV camera itself replace a conventional camera with simple photographing function. These function modules are integrated in an image SOC like a CCTV camera control device 400 shown in this figure. The smart image processing CCTV camera of the present invention can process various images by itself without needing the equipment of a monitor center. Moreover, the quality of audiovisual frames can be maintained.

The image SOC in FIG. 4 comprises several function modules each controlled by a central processor. The image SOC comprises:
1. An image sensor processing unit 401, which is externally connected with an image sensor 41 for controlling the image sensor 41 to receive an optical image via a lens 43 for adjusting the focus, exposure, and conversion into a digital signal;
2. A color image processing unit 402, which receives the digital image signal of the image sensor processing unit 401 for performing interpolation, automatic white balance, sharpening, RGB to YCbCr conversion, and so on, to attain optimal image quality;
3. A motion image analysis and tracking unit 403, which receives the digital signal of the color image processing unit 402, operates and compares continuous digital images captured by the device to detect any object's movement, its direction and speed, and controls the horizontal and vertical motion of the lens via an external control unit 407 and an optical or digital zoom, to get the most clear frame of the moving object. A motion image analysis and tracking algorithm is preset on the motion image analysis and tracking unit 403. The motion image analysis and tracking unit 403 comprises three modules (not shown in this embodiment)—a change detection module, a motion tracking module, and a camera control module. The change detection module is responsible for detecting a moving object. The motion-tracking module is responsible for determining the priorities that are used to track a moving object. The camera control module is responsible for controlling the horizontal and vertical movement of the camera to track an object, and zooming in on the image to attain an appropriate image size. The change detection module uses a motion compensation algorithm to detect change in a timely and reliable fashion under the premise that the camera can turn. To achieve this, each frame is partitioned into many small motion blocks, and the previous and subsequent individual blocks are compared with each other to get the motion vector of each individual block. After the motion vector of each small block is calculated, the median of the motion vectors of these blocks is taken as the entire motion vector. Using the entire motion vector for motion compensation of the entire image, the vector motion block diagrams of the entire moving object can be obtained. The motion-tracking module determines the primary moving object within these many motion blocks. First, the vector motion block diagrams are joined to form several motion regions. Because different motion regions of the same moving object will overlap one another, these overlapping parts can be reasonably assembled together to form a large motion part. A tracking window is formed for this motion part. Information, such as the motion vector of the moving object and the position and size of the previous image of the tracked object provided in this window, are used to assist in continually tracking the object. Once an object has been locked onto, the camera control module controls the camera to make horizontal or vertical movements so that the object is always shown at the center of the display module. The camera control module has artificial intelligence (AI), which can be set by the user. Based on the size and scale of the moving object, the key part, or other settings, the camera control module can automatically activate optical or digital zoom functions through an external control unit 407, to magnify the entire moving object or its key part (e.g., head), thereby getting a clear image;
4. An image compression/decompression unit 404, which performs compression and decompression actions to static or dynamic images to facilitate storage or replay after image processing of the motion image analysis and tracking unit 403;
5. A central processing unit 406, which is connected with various units of the camera control device 400 for receiving the image signal of said image compression/decompression unit for controlling each functional module in the SOC and coordinating the operations of the entire system;
6. A memory medium control unit 405, which is connected to an access storage medium 45 and the central processing unit 406 for controlling write/read of the image signal on various storage media. The memory medium control unit 405 performs on-line control of temporary memories during system operation and off-line control of image storage media;
7. An external control unit 407, which outputs or receives the control signal of the central processing unit 406 and communicates with external components or systems for controlling the focus, zoom, vertical and horizontal motion of the lens 43. It can also be operated by a remote host 47 to perform replay or manual adjustment of the lens 43;
8. An analog image signal transmission interface 409, which is electrically connected to the central processing unit 406 for converting the image signal into an analog format (e.g., NTSC or PAL) and outputting the analog image signal to the remote host 47; and
9. A digital image signal transmission interface 411 (e.g., a USB interface or a wired or wireless network interface), which is electrically connected to the central processing unit 406 for converting the image signal into a digital format and outputting the digital image signal to the remote host 47.

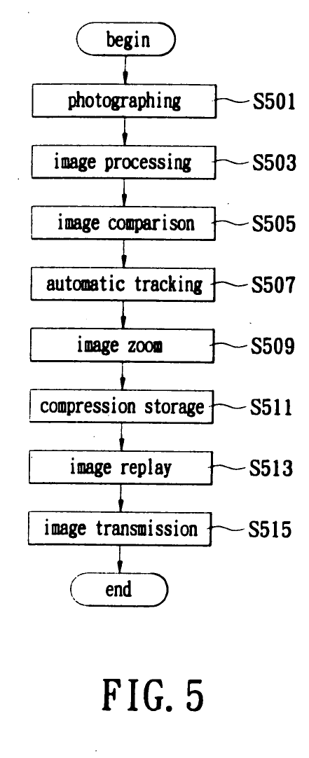

FIG. 5 is a flowchart for operating a smart image processing CCTV camera of the present invention. This method comprises the following steps.
1. Taking an image (Step S501): The smart image processing CCTV camera captures a digital image by means of a predetermined program, waiting at a fixed position, or being remotely controlled in a wired or wireless way in analog or digital format through an image sensor processing unit;
2. Processing the image: A color image processing unit is used to perform interpolation, white balance, clarification, sharpening, or noise reduction to the captured image (Step S503);
3. Performing image comparison: A motion image analysis and tracking unit in the camera is used to compare images to determine the difference between the image stored in the temporary memory and the presently captured image (Step S505);
4. Performing automatic tracking: The camera activates an automatic tracking mode to move the lens for focusing upon and photographing the motion image when the photographed object is found to have moved (Step S507);
5. Performing image zoom: Digital or optical zoom is performed to the tracked moving object (Step S509);
6. Performing compression and storage: The captured image is compressed and stored in a storage medium in digital format (Step S511);
7. Performing image replay: The digital image stored in the storage medium is decompressed and converted into an analog or digital signal that can be replayed immediately (Step S513); and
8. Performing image transmission: The digital image is transmitted to the remote host immediately or at a later time in a wireless or wired way. Actions of zoom or replay of frame can be performed on a monitor of the remote host to inform monitoring staff of relevant actions (Step S515).

In the present invention, the CCTV camera analyzes the captured image and performs image tracking upon the captured image by itself through the motion image tracking unit disposed in the camera.

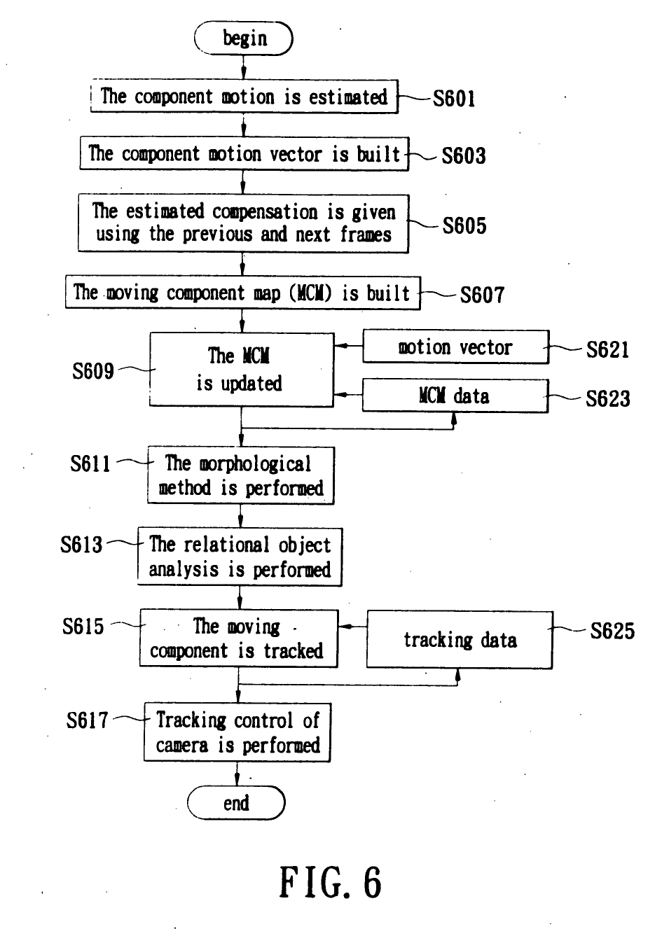

FIG. 6 is a flowchart of object tracking according to the most preferred embodiment of the present invention. This method comprises the three primary steps of object motion detection, object tracking, and camera control.

Step 601: The motion behavior of the object is determined by means of the difference between previous and subsequent frames of the temporarily stored image through the audiovisual temporary storage function of the CCTV camera of the present invention itself;

Step S603: The motion vector of the object is built by means of the mutual relation of the previous and subsequent frames like the (n−1)th frame and the nth frame;

Step 605: The estimated motion behavior of the object is compensated for through the motion vector. That is, motion compensation is made to the estimated value with the previous and subsequent frames;

Step S607: A moving component map (MCM) is built with the above motion estimation. The MCM data stored to a storage medium is updated momentarily, and a relational map is built with the motion vector of the object. For instance, the edges of the motion image are used to define the moving range of the motion image and the relation with surrounding things;

Step S609: Update of the MCM is performed momentarily using the motion vector 621 and the MCM data 623 previously stored to the storage medium;

Step S611: The above MCM is used to perform a morphological method;

Step S613: The difference between the motion object and relevant objects is analyzed by the above morphological method;

Step S615: A piece of tracking data 625 is built through the analysis of the difference between the motion object and relevant objects, and the tracking data 625 is updated momentarily with the analysis data;

Step S617: When tracking the moving object, the present method is performed, and a camera tracking control signal is produced to control the photographing and image processing behaviors of the CCTV camera of the present invention.

During the process of obtaining an image from an image sensor, in order to get better image quality, a series of image processes will be immediately performed. The objectives of these image processes include digitizing the signal, getting accurate brightness, avoiding color shifting under light sources with different color tones, making the image clearer, and obtaining a higher compression ratio. After these image processes are completed, in addition to converting and outputting messages compatible with analog CCTV, the digital data will be compressed to reduce the amount of data and then stored to a digital storage media connected with the system. The stored digital data can be directly read from the storage media, and can also be converted to analog signals and, after receiving commands from the host end, sent back to the host end.

The smart image processing CCTV camera device of the present invention can detect a moving object by performing operations and analysis based purely on the captured image without any external equipment or device. The smart image processing CCTV camera device can determine the moving direction and speed of the moving object, and then move the lens to always place the invasive object in the photographing range. Moreover, the smart image processing CCTV camera device can automatically choose optical or digital zoom to ensure that the entire moving object or the monitored key point occupies the entire photographing range as much as possible, thereby obtaining the clearest image of the moving object.

To sum up, the present invention provides a smart image processing CCTV camera device and a method for operating the same. The camera can process, compress, and store digital images, as well as zooming in upon the captured images by itself. Analog or digital signals can be restored immediately or at a later time for transmission or replay. In other words, motion image analysis and tracking can be performed upon the captured images to monitor and obtain a clear image.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A smart image processing CCTV camera device capable of performing digital image processing and also motion image analysis and tracking upon a captured image by itself to monitor and obtain a clear image, said device comprising a highly integrated image SOC, said highly integrated image SOC at least comprising:
an image sensor processing unit externally connected with an image sensor for controlling said image sensor to adjust the focus, exposure, and conversion into a digital signal;
a color image processing unit, which receives said digital image signal of said image sensor processing unit for performing interpolation, automatic white balance, sharpening, RGB to YCbCr conversion, and so on to obtain optimal image quality;
a motion image analysis and tracking unit, which receives said digital signal of said color image processing unit for comparing continuous digital images captured by said device to detect motion of an object and its moving direction and speed and controlling the horizontal and vertical motion of a lens via an external control unit and the optical or digital zoom to get the clearest image of a moving object;
an image compression/decompression unit, which compresses and decompresses actions to static or dynamic images to facilitate the storage or replay after processing the image by said motion image analysis and tracking unit;
a central processing unit, which receives said image signal of said image compression/decompression unit and is connected to each component of said device for controlling each functional module in said SOC and coordinating operations of the entire system;
a memory medium control unit, which receives said image signals from said central processing unit for controlling write-in and readout of said image signals on various storage media, said memory medium control unit performs on-line control of temporary memories during system operation and off-line control of image storage media;
an external control unit, which outputs or receives said control signal of said central processing unit and communicates with external components or systems for controlling the focus, zoom, vertical and horizontal motion of a lens or is operated by a host to replay or manually adjust said lens;
an analog image signal transmission interface electrically connected to said central processing unit for converting said image signal into an analog format and outputting said analog image signal; and
a digital image signal transmission interface electrically connected to said central processing unit for converting said image signal into a digital format and outputting said digital image signal.

2. The smart image processing CCTV camera device as claimed in claim 1, wherein said external control unit receives a control signal from a remote host.

3. The smart image processing CCTV camera device as claimed in claim 1, wherein said image sensor can be a CCD sensor or a CMOS sensor.

4. The smart image processing CCTV camera device as claimed in claim 1, wherein said motion image analysis and tracking unit at least comprises a change detection module, a motion tracking module, and a camera control module.

5. The smart image processing CCTV camera device as claimed in claim 1, wherein said digital image signal transmission interface is used to transmit audiovisual signals in a wireless or wired way.

6. A method for operating a smart image processing CCTV camera device, said smart image processing CCTV camera device being capable of performing digital image processing and also motion image analysis and tracking upon a captured image by itself to monitor and obtain a clear image, said method comprising the steps of:
capturing an image;
performing image processing;
performing image comparison;
performing automatic tracking;
performing image zoom;
performing compression and storage;
performing image replay; and
performing image transmission.

7. The method for operating a smart image processing CCTV camera device as claimed in claim 6, wherein said step of capturing an image can be accomplished by means of a predetermined program, waiting at a fixed position, or remote control in a wired or wireless way of a camera in analog or digital format.

8. The method for operating a smart image processing CCTV camera device as claimed in claim 6, wherein in said step of performing image transmission, audiovisual signals are transmitted in a wireless or wired way.

9. The method for operating a smart image processing CCTV camera device as claimed in claim 6, wherein said step of performing image comparison is accomplished by comparing an image stored in a temporary memory and the presently captured image.
